(19) United States
(12) Patent Application Publication
(10) Pub. No.: US 2015/0053800 A1
(43) Pub. Date: Feb. 26, 2015

(54) PLANT FOR CRUSHING MINERAL MATERIALS

(71) Applicant: VICAT, Paris La Defense (FR)

(72) Inventor: Marcel Bourgeois, Saint-Egreve (FR)

(73) Assignee: VICAT, Paris La Defence (FR)

(21) Appl. No.: 14/377,480

(22) PCT Filed: Feb. 7, 2013
(86) PCT No.: PCT/FR2013/050259

§ 371 Date: Nov. 5, 2014

(30) Foreign Application Priority Data
Feb. 8, 2012 (FR) 12/51159

(51) Int. Cl. B02C 23/32; B02C 23/14; B02C 23/12; B02C 4/02; B02C 4/28

(52) U.S. Cl. CPC B02C 23/32; B02C 4/02; B02C 4/286; B02C 23/12; B02C 23/14
USPC 241/49; 241/47

(57) ABSTRACT

The invention concerns a plant (50) for crushing mineral materials comprising:—a hermetic enclosure (2);—at least one press (30) housed inside the enclosure (2), arranged to crush the mineral materials;—at least a first separator (42) housed inside the enclosure (2), arranged to separate: residual coarse particles from the roller press (30); and fine particles and intermediate particles from the roller press (30);—a second separator (27) housed inside the enclosure (2), arranged to separate the fine particles from the intermediate particles; and—suction means configured to extract only the fine particles via a first extraction duct (8).

### TECHNICAL FIELD

The present invention relates to a plant for crushing mineral materials, in particular for the equipment of a cement plant.

### BACKGROUND

Cement manufacturing involves a plurality of steps. Typically, during an extraction step, blocks of mineral materials are quarried then ground. During a first crushing step, the ground mineral materials are crushed to give a raw material. During a curing step, the raw material is cured at a temperature of about 1450° C. to give a clinker. Finally, during a second crushing step the clinker is mixed with an additional ground mineral material, for example gypsum, then crushed to give a cement of the desired composition.

The electric consumption resulting from the implementation of the first and second crushing steps represents between 50% and 80% of the total electric consumption of a cement factory.

Out of an ongoing concern to reduce the operating costs and the environmental impact of such factories, the plants for crushing mineral materials have evolved over the last twenty years.

Until the 1980s, such plants used to use ball crushers according to a crushing method which consists of passing the material to be crushed through a horizontal rotating tube containing metal balls. This principle of crushing the material has a very low energy efficiency.

Subsequently, the plants gradually evolved towards the principle of crushing in a material bed which offers a more favorable energy efficiency. This was realized through the adoption of vertical roller crushers. The strong gain in energy efficiency which accompanied these technologies is counterbalanced by an increased complexity of the plant and, by the need to wet the material to be crushed, thus adding an additional drying step which is costly in thermal energy.

Simultaneously, both metallurgical improvements and methods for granulometrically separating the material improvements, have enabled the development of crushing with a roller press. This crusher type, which also uses the principle of crushing in a material bed, offers, owing to the use of gravity for the admission of the material, both reduced energy consumption and a simplification of the crushing plant.

Today, plants for crushing mineral materials with a roller press conventionally comprise a static cascade-type separator, a dynamic third generation type separator and a roller press.

Such a plant, even if perfectly adapted for ensuring a suitable granulometry of the final product, still consumes a substantial amount of energy.

Moreover, the roller press, the static cascade-type separator and the dynamic separator are separately arranged and must then be disposed inside a large workshop.

Such a plant requires the use of a high-capacity elevator ensuring a circulating load of at least five times the output of the plant. When the capacity of the elevator exceeds the limits of the technique, it is necessary to dispose two elevators in parallel, which increases the cost of the plant.

Finally, such a plant cannot accept a moisture content of mineral materials greater than 4%. In the opposite case, the condensation phenomena may cause the clogging of the rollers.

### BRIEF SUMMARY

The invention aims to overcome all or part of these drawbacks.

The invention relates to a compact plant for crushing mineral materials, in particular for the equipment of a cement plant, characterized in that it comprises:
a hermetic enclosure extending along a vertical direction, said enclosure comprising at least one first mouth connected to a supply duct of the mineral materials, a second mouth connected to a first duct for extracting fine particles, a third mouth connected to a second duct for extracting residual coarse particles, and a fourth gas inlet mouth;
at least one roller press housed inside the enclosure in an intermediate portion thereof, the roller press being arranged for crushing the mineral materials, in such a manner as to form fine particles, intermediate particles, and residual coarse particles;
at least one first separator, preferably of cascade type, housed inside the enclosure in a lower portion thereof, arranged to separate:
on the one hand, the residual coarse particles from the roller press with a view to their extraction by the second extraction duct; and
on the other hand, the fine particles and the intermediate particles from the roller press;
a second separator, preferably dynamic, housed inside the enclosure in an upper portion thereof, arranged to separate the fine particles from the intermediate particles, with a view to crushing the intermediate particles by the roller press; and
suction means configured to extract only the fine particles by the first extraction duct.

It should be observed that the plant according to the invention in no way consists in connecting in series, by ducts, a roller press, a first separator and a second separator housed in respective enclosures, but comprises in housing within a same enclosure at least one roller press, a first separator and a second separator.

By “vertical direction” a substantially rectilinear upward direction is meant.

A dynamic separator is for example of the third generation which implements centrifugal force to separate the fine particles from the intermediate particles, while the separators of the first and the second generations only use gravity.

The plant according to the invention is for example applied for implementing the first or second crushing step.

In operating conditions, the mineral materials brought into the enclosure through the supply duct are crushed by the roller press, forming residual coarse particles, intermediate particles and fine particles.

The residual coarse particles, the intermediate particles and the fine particles are separated by the first separator. On the one hand, the residual coarse particles are extracted by the second extraction duct, preferably to be crushed anew.

On the other hand, the fine and intermediate particles are carried away by a upward gaseous current in the vicinity of the second separator, in part thanks to the suction means, participating in the circulation of said gaseous current.

The second separator separates the intermediate particles from the fine particles. On the one hand, the suction means extract the fine, light particles, by the first extraction duct. On the other hand, the intermediate, heavier, particles fall by gravity into the roller press, with a view to be crushed anew.

The mineral materials are brought from the supply duct to the roller press, and from the roller press to the first separator by gravity.

Furthermore, the main components of the plant are grouped in a same enclosure which limits material transfer means from one component to another, and consequently the energy consumption of the plant.

Only the residual coarse particles are extracted from the enclosure by the second extraction duct, which allows minimizing the quantity of particles liable to be reintroduced into the enclosure through the supply duct. In addition, the energy and capacity required for an elevator to collect the residual coarse particles from the second extraction duct and lift these residual coarse particles up to the supply duct are reduced.

Such a plant allows a downward circulation of mineral materials in the enclosure by gravity via the roller press and an upward circulation of hot gas in counter-current with the mineral materials, via the roller press.

By “hot gas”, is meant gases of which the temperature ranges between room temperature and 250° C.

Thus, the hot gases dry the mineral materials as soon as they are introduced into the enclosure, then through the roller press. The hot gases also allow the heat-up of the plant and maintaining in temperature.

It is thus possible to introduce moist mineral materials directly into the enclosure. The moisture of the mixture to be crushed is no longer limited to 3 or 4%, but may be compared to the moisture accepted by the vertical roller crushers namely 15%. The crushing operations are thus performed at optimum crushing temperature which is around 80/90°. Thus, possible drying operations prior to the introduction of mineral materials into the enclosure can be removed.

Moreover, when the plant is used for manufacturing cement, it is possible to adjust the temperature of the hot gases at the exit of the roller press, in such a manner as to control the dehydration of the gypsum.

Furthermore, the heaviest intermediate particles upwardly driven by the hot gases fall by their own weight into the roller press without reaching the second separator. The lightest intermediate particles are driven to the second separator where they are sorted with the fine particles and return to the roller press to be crushed anew.

The intermediate particles are thus re-circulated within the enclosure until they become fine particles liable to be carried away by the hot gases to the second separator and then through the second mouth. More specifically, part of the intermediate particles is re-circulated in the roller press under the effect of the second separator. Another part of the intermediate particles is re-circulated in the roller press as a result of gravity.

It is thus possible to reduce:
the quantity of particles re-circulated outside the enclosure and hence to reduce the capacity and power of the conveying means outside the enclosure;
the quantity of intermediate particles driven to the second separator;
The size of the second separator resulting from the increase of the inner recirculation without having to pass by the second separator and from the decrease of the outer recirculation.

It is finally possible to reduce the pressure applied between the rollers, and consequently improve the efficiency of the roller press (efficiency being expressed in kWh/ton).

The plant according to the invention may comprise one or several of the following features.

According to one feature, the enclosure is stationary.

According to another feature, the second mouth opens into the enclosure in an upper portion thereof, and the fourth gas inlet mouth opens into the enclosure in a lower portion thereof.

Preferably, the second mouth opens into the enclosure above the second separator, and the fourth gas inlet mouth opens below the first separator.

According to one feature, the roller press and the second separator are arranged inside the enclosure in such a manner as to preserve a space allowing at least one portion of the intermediate particles carried away by hot gases, particularly the heaviest, to fall in the roller press by gravity, without passing through the second separator.

Preferably, the press comprises a device for regulating the velocity of the gases located for example at the horizontal median plane of the roller press. This device may comprise partially or completely blocked openings.

In its preferred embodiment, the or each first separator comprises:
at least one grid arranged to disaggregate agglomerates of fine, intermediate, and residual coarse particles from the roller press, and guide by gravity the residual coarse particles to the second extraction duct, and
blowing means arranged to blow hot gases through the meshes of said grid, in such a manner as to carry away the fine particles and the intermediate particles from the roller press in the vicinity of the second separator.

In operating conditions, the intermediate and fine particles from the roller press, which are light, are carried away in the vicinity of the second separator by the hot gases blown through the meshes of the grid and by the suction means.

The fine particles are then sucked by the extraction duct while the intermediate particles fall by gravity with a view to being crushed by the roller press.

The heavier residual coarse particles, are guided by the grid to the second extraction duct with a view to being extracted from the enclosure, and lifted to the supply duct.

Advantageously, the blowing means comprise at least one gas blowing duct opening inside the enclosure by the or each fourth mouth, said blowing duct being in fluid connection with the first extraction duct, in such a manner that the hot gases extracted from the enclosure by the first extraction duct be blown again into the enclosure by the blowing duct.

According to one feature, the plant comprises a funnel disposed under the second separator to collect the intermediate particles rejected by this second separator, and the mineral materials brought by the supply duct, and power the roller press with these intermediate particles and these mineral materials.

The funnel then ensures the function of refusal cone.

Preferably, the supply duct and the second extraction duct are each equipped with a sealing lock.

In these conditions, the pressure inside the enclosure is not altered by the ambient air at atmospheric pressure during the supply of the mineral materials by the supply duct or the extraction of the residual coarse particles by the second extraction duct.

According to one feature, the plant includes conveying means arranged to collect the residual coarse particles from the second extraction duct and to lift these residual coarse particles up to the supply duct.

According to one feature, the plant includes:
a hopper supplied in mineral materials, housed within the enclosure above the roller press;
means for measuring a magnitude representative of the quantity of mineral materials contained in the hopper, such as the mass or the filling level of the hopper.

The intermediate particles carried away by the hot gases and falling by gravity without passing through the second separator are advantageously collected by the hopper.

The measuring means allow regulating the quantity of material in the hopper, by increasing or reducing the output of mineral material brought by the supply duct according to the measurement.

According to another feature, the plant comprises blocking and adjusting means suited to adjust the thickness and the position of the stream of material above the air gap between the rollers.

For example, the blocking and adjusting means comprise:
blocking means moveable in a blocking position and in a release position, respectively, preventing and allowing the supply of the roller press with mineral materials;
first motor means configured to move the blocking means in their release position or in their blocking position,
adjusting means moveable with respect to the blocking means; and
second motor means configured to move the adjusting means with respect to the blocking means, to adjust the thickness and the position of the material stream above the air gap between the rollers.

The blocking and adjusting means may take the shape of lower flaps and upper flaps disposed under the hopper.

The combination of the first and second blocking and adjusting means allows optimizing the output, expressed in tons per hour, and the efficiency, expressed in kilo Watt hours per ton (kWh/t), of the plant.

Furthermore, such a combination improves the crushing stability of the roller press. Indeed, the blocking means allow balancing the power absorbed by each roller and the adjusting means allow saturating the air gap between the rollers.

Advantageously, the or each roller press comprises at least a first and a second roller rotatably mounted about substantially parallel axes, and adjusting means adapted to adjust the width of the air gap separating the first and the second rollers.

Preferably, the axes of the rollers are horizontal.

Preferably, the or each roller press is combined with a respective first separator, each first separator comprising two portions of grids inclined with respect to each other, the portions of the grids exhibiting lower edges turned towards a second respective mouth and upper edges joined to each other and disposed vertically with the air gap separating the first and the second rollers.

Thus, the plant is equipped with a double separator.

In one embodiment, the suction means comprise a fan disposed outside the enclosure.

According to one feature, the second separator comprises a turbine rotatably mounted within the enclosure and a plurality of bladings fixed inside of the enclosure concentric with the turbine.

### BRIEF DESCRIPTION OF THE DRAWINGS

The invention will be better understood from the following description with reference to the accompanying schematic drawing representing, by way of non-limiting example, a plant for crushing mineral materials according to the invention.

FIG. 1 is a schematic front view of an assembly of a crushing plant according to the invention;

FIG. 2 is a partial schematic side view of the assembly of FIG. 1; and

FIG. 3 is a partial schematic view of the plant equipped with the set of FIGS. 1 and 2.

### DETAILED DESCRIPTION

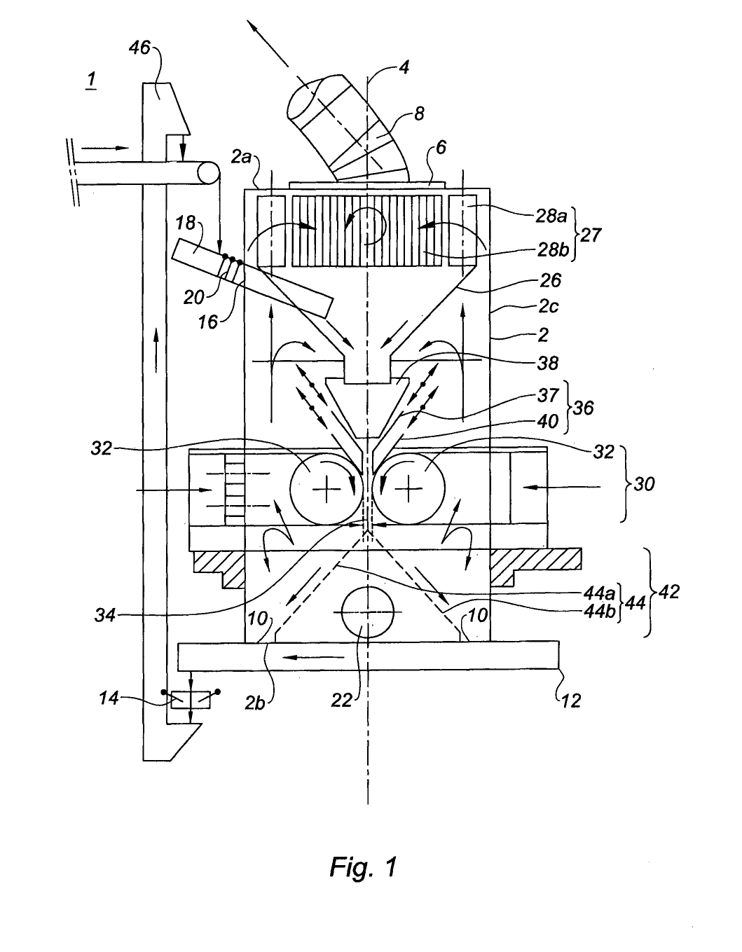

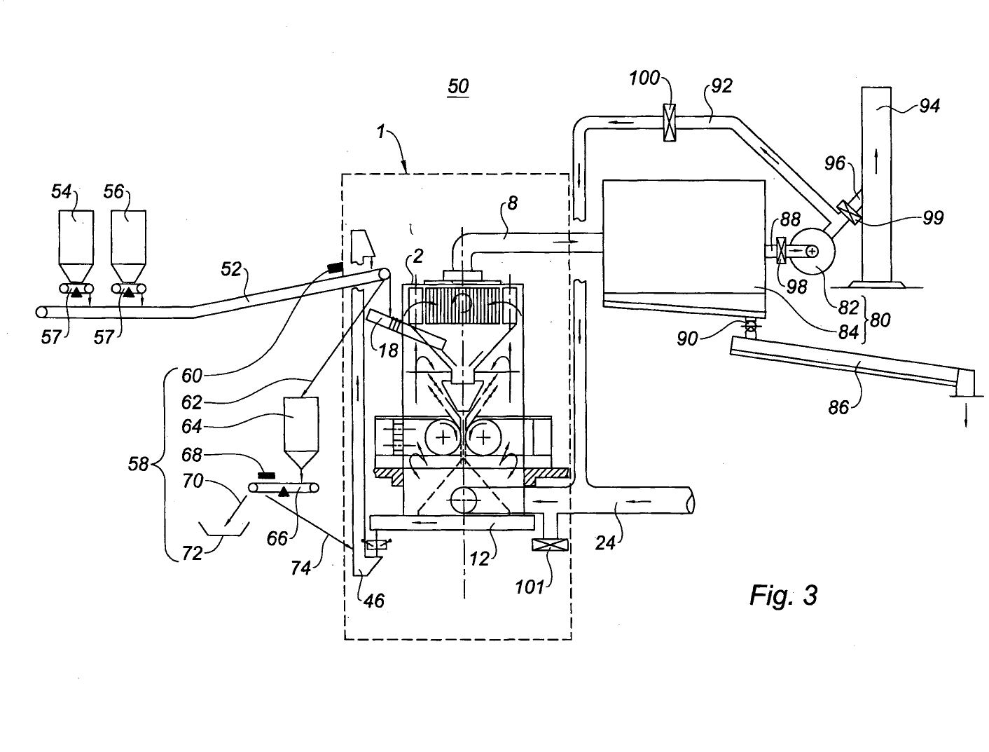

FIG. 1 represents an assembly 1 for a plant 50 for crushing (represented in FIG. 3). The assembly 1 comprises a stationary hermetic enclosure 2 extending along a main vertical direction 4. The enclosure 2 comprises an upper wall 2a, a lower wall 2b and at least one side wall 2c connecting the upper 2a and lower 2b walls.

The enclosure 2 comprises a mouth 6 arranged through the upper wall 2a. This mouth 6 is connected to an extraction duct 8 of fine particles.

The enclosure 2 comprises two mouths 10 arranged through the lower wall 2b. The mouths 10 are connected to an extraction duct 12 of residual coarse particles. The extraction duct 12 is equipped with a seal lock 14, here of pendulum type, and conveying means (not represented).

The enclosure 2 comprises a mouth 16 arranged through the side wall 2c. This mouth 16 is connected to a supply duct 18 of mineral materials. The supply duct 18 is equipped with a seal lock 20, here with triple valves. Alternatively, the seal lock 20 may be of honeycomb rotary type.

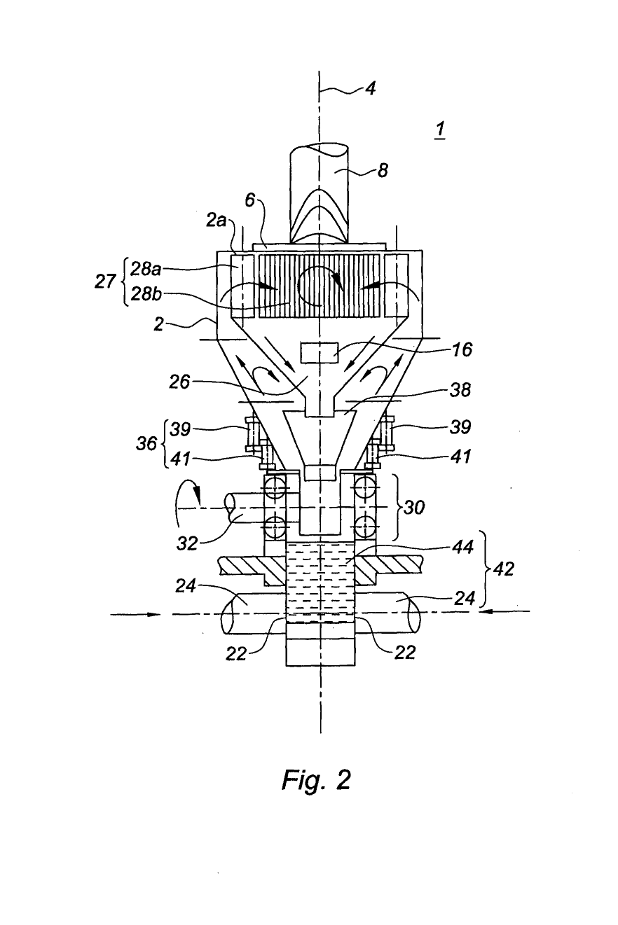

The enclosure 2 finally comprises mouths 22 arranged through the side wall 2c. These mouths 22 are connected to blowing ducts 24 of a hot gas (represented in FIGS. 2 and 3).

The assembly 1 includes a separator 27, housed inside the enclosure 2, in the upper portion thereof. The function of the separator 27 is subsequently specified.

The separator 27 is a third generation dynamic separator. The separator 27 comprises blades 28a fixed inside the enclosure 2 and a turbine 28b rotatably mounted inside the enclosure 2 vertically with the mouth 6. The turbine 28 is suited to adjust the fineness of the finished product, its speed being increased in order to refine the finished product and reduced to magnify the finished product.

The assembly 1 comprises a funnel 26 or a refusal cone housed inside the enclosure 2. The funnel 26 is disposed under the turbine 28, vertically with this turbine 28 and arranged in such a manner that the supply duct 18 discharges the mineral materials inside this latter.

The assembly 1 comprises a press 30 housed inside the enclosure 2 in an intermediate portion thereof. The press 30 is arranged to crush the mineral materials discharged into the funnel in such a manner as to form fine particles, intermediate particles and residual coarse particles.

The press 30 comprises two rollers 32 rotatably mounted about substantially parallel axes. By way of example, here the axes are horizontal, and the rollers 32 exhibit a substantially equal diameter.

The press 30 comprises adjusting means (not represented) suited to adjust the width of the air gap 34 separating the rollers 32.

The assembly 1 comprises a hopper 38 supplied by the funnel 26. The hopper 38 is disposed between the funnel 26 and the press 30, vertically with the funnel 38 and the press 30.

The assembly 1 comprises means (not represented) for measuring the mass of mineral materials contained in the hopper 38 or the height of the mineral materials contained in the hopper 38.

The assembly 1 further comprises blocking and adjusting means 36 suited to adjust the thickness and the position of the stream of material above the air gap 34 between the rollers 32.

The blocking and adjusting means 36 comprise:
blocking means 40 moveable in a blocking position and a release position, respectively, preventing and allowing the supply of the roller press 30 with mineral materials;
first motor means 41, such as actuators, configured to move the blocking means 40 in their release position or in their blocking position;
adjusting means 37 moveable with respect to the blocking means 40; and
second motor means 39, such as actuators, configured to move the adjusting means 37 with respect to the blocking means 40 in such a manner as to adjust the thickness and the position of the stream of material above the air gap 34 between the rollers 32.

The assembly 1 comprises a separator 42 housed inside the enclosure 2, in the lower portion thereof. The separator 42 is arranged to separate on the one hand the fine particles and the intermediate particles, and on the other hand the residual coarse particles from the press 30.

The separator 42 is a static cascade-type separator. The separator 42 comprises a grid 44 arranged to guide by gravity the residual coarse particles from the press 30 to the mouths 10.

In the represented embodiment, the grid 44 comprises two portions of grids 44a, 44b inclined with respect to one another. The portions of grids 44a, 44b each exhibiting a lower edge turned towards a respective mouth 10 and an upper edge opposite to the lower edge. The upper edges of the portions of grids 44a, 44b are joined and disposed vertically with the air gap 34 separating the rollers 32.

The separator 42 further comprises blowing means arranged to blow hot gas through meshes of the grid 44, in such a manner as to suspend fine particles and intermediate particles from the press 30 inside the enclosure 2 and allow their suction by the duct 8 under the action of a fan 82 (represented in FIG. 3) generating a upward gaseous current inside the enclosure 2.

The assembly 1 comprises conveying means arranged to collect the residual coarse particles from the extraction duct 12 and to supply the supply duct 18 with these residual coarse particles. For example, the conveying means comprise a bucket elevator 46.

During the operation of the assembly 1, the fan 82 and the blowing ducts 24 make an upward gaseous current circulate.

The mineral materials are discharged by the supply duct 18 into the funnel 26, then into the hopper 38 with a view to being crushed by the roller press 30.

The press 30 crushes the coarse particles from the hopper 38 to form residual coarse particles, intermediate particles and fine particles.

The intermediate particles and the fine, light particles from the press 30, are carried away in the vicinity of the separator 27 by the upward gaseous current.

The separator 27 separates the intermediate particles from the fine particles. On the one hand, the fine light particles, are sucked under the action of the fan 82 by the duct 8. On the other hand, the heavier intermediate particles, fall by gravity into the funnel 26, with a view to being crushed by the roller press 30.

The size of the fine particles sucked by the duct 8 is determined by the output of hot gas circulating in the enclosure 2, and by the speed of rotation of the turbine 28b.

The residual coarse particles from the roller press 30, too heavy to be carried away by the air blown by the blowing ducts 24, fall by gravity on the portions 44a, and 44b of grids and are guided by the portions 44a and 44b of grids towards the mouths 10, then are transported, for example by a mass transporter disposed in the extraction duct 12, towards the conveyor 46 with a view to re-supplying the supply duct 18.

The press 30 and the separator 27 are arranged inside the enclosure 2 in such a manner as to arrange a space 31 to allow the heaviest intermediate particles carried away by the hot gases to fall into the press 30 by gravity, without passing through the separator 27.

When aggregates of intermediate particles and fine particles are formed in the press 30, the latter, too heavy to be carried away by the air blown by the blowing ducts 24, fall by gravity on the portions 44a and 44b of grids and disintegrate. The disaggregated intermediate particles and fine particles are carried away in the vicinity of the turbine 28 by the hot gases blown by the blowing ducts 24. The fine particles are then sucked by the extraction duct 8 while the intermediate particles, fall by gravity into the funnel 26.

FIG. 3 represents the crushing plant 50 equipped with the assembly 1.

The plant 50 here comprises a conveyor 52 belt.

The plant 50 comprises, by way of example, two hoppers 54 and 56 containing mineral materials, such as clinker and gypsum. The hoppers 54 and 56 are arranged to discharge in a predetermined proportion the clinker and the gypsum on the belt of the conveyer 52 and to form a mixture of mineral materials. To this end, the hoppers 54 and 56 are each equipped with a weight feeder 57 with belt.

The conveyor 52 supplies the supply duct 18 with said mineral granular composition.

The plant 50 includes a sorting system 58 comprising:
a first metal detector 60 for detecting the presence of metal particles in the mineral materials discharged on the conveyor belt 52;
a duct 62 for redirecting the mineral materials disposed on the belt of the conveyor 52 towards a surge hopper 64, when the presence of metal particles is detected by the metal detector 60;
a weight feeder 66 with belt, on which the mineral materials contained in the surge hopper 64 are discharged;
a second metal detector 68 for detecting the presence of metal particles in the mineral materials discharged into the weight feeder 64;
a duct 70 for redirecting the mineral materials discharged on the weight feeder 66 towards a discharge hopper 72, when the presence of metal particles is detected by the metal detector 68; and
a duct 72 for redirecting the mineral materials discharged on the weight feeder 66 towards the conveyor 46, in the absence of detection of metal particles by the metal detector 68.

The plant 50 finally comprises a filtration device 80 arranged for filtering a mixture of gas and fine particles extracted from the enclosure 2 by the extraction duct 8. In the example, the filtration device 80 comprises a filter 84 and the fan 82.

The fine particles extracted by the filtration device 80 are received in an air slide 86, and the hot gases by a vent duct 88.

The air slide 86 leads the fine particles in a storage silo (not represented). The air slide 86 is connected to the filter 84 by a seal lock 90, for example a rotary honeycomb one.

The vent duct 88 is connected to the blowing ducts 24 by a recirculation pipe 92. Thus, the blowing ducts 24 are in fluid connection with the extraction duct 8, and the hot gases extracted from the enclosure 2 by the extraction duct 8 may be blown again into the enclosure 2 by the blowing ducts 24.

The vent duct 88 is connected to a chimney 94 by an exhaust pipe 96, in such a manner that a surplus of hot and/or moist gas may be released.

The recirculation 92 and exhaust 96 pipes, and the blowing ducts 24 are equipped with valves, respectively, 98, 99, and 100, and a fresh air inlet flap 101 allowing to regulate the output, the pressure, and the temperature of the gas blown into the enclosure 2 through the blowing ducts 24 or expelled by the chimney 94.

The invention is not limited to the sole embodiment of the plant described above by way of example, but encompasses all alternative embodiments.

Alternatively, the plant may comprise a plurality of roller presses substantially disposed at the same height inside the enclosure. In these conditions, each roller press is preferably associated with a respective separator 42. Still alternatively, the rollers of each roller press may exhibit identical or different diameters. The axes of the rollers may be disposed in a horizontal or oblique plane, that is to say, forming a non-zero angle with the horizontal plane.

Alternatively, at least one roller may be movably mounted with respect to the other roller by at least one hydraulic actuator, in order to adjust the air gap and that it can be removed in the face of an agglomerate of large and hard particles brought to the roller press.

Still alternatively, the plant may comprise one or several cascade-type separators each comprising one single grid portion extending in an oblique plane.

1. A plant for crushing mineral materials, in particular for the equipment of a cement plant, comprising:
a hermetic enclosure extending along a vertical direction, said enclosure comprising at least one first mouth connected to a supply duct of the mineral materials, a second mouth connected to a first duct for extracting fine particles, a third mouth connected to a second duct for extracting residual coarse particles, and a fourth gas inlet mouth ;
at least one roller press housed inside the enclosure in an intermediate portion thereof, the roller press being arranged for crushing the mineral materials, in such a manner as to form fine particles, intermediate particles, and residual coarse particles;
at least one first separator of cascade type, housed inside the enclosure in a lower portion thereof, arranged to separate:
the residual coarse particles from the roller press with a view to their extraction by the second extraction duct; and
the fine particles and the intermediate particles from the roller press;
a second separator, dynamic, housed inside the enclosure in an upper portion thereof, arranged to separate the fine particles from the intermediate particles, with a view to crushing the intermediate particles by the roller press; and
suction means configured to extract only the fine particles by the first extraction duct.

2. The plant according to claim 1, wherein the roller press and the second separator are arranged inside the enclosure in such a manner as to preserve a space to allow at least part of the intermediate particles carried away by hot gases to fall in the roller press by gravity, without going through the second separator.

3. The plant according to claim 1, wherein the or each first separator comprises:
at least one grid arranged to disaggregate agglomerates of fine, intermediate and residual coarse particles from the roller press, and guide by gravity the residual coarse particles to the second extraction duct, and
blowing means arranged to blow hot gases through the meshes of said grid, in such a manner as to carry away the fine particles and the intermediate particles from the roller press in the vicinity of the second separator.

4. The plant according to claim 3, wherein the blowing means comprise at least one gas blowing duct opening inside the enclosure by the or each fourth mouth, said blowing duct being in fluid connection with the first extraction duct, in such a manner that the hot gases extracted from the enclosure by the first extraction duct be blown again into the enclosure by the blowing duct.

5. The plant according to claim 3, further comprising a funnel disposed under the second separator for collecting the intermediate particles rejected by this second separator, and the mineral materials brought by the supply duct, and supplying the roller press with these intermediate particles and these mineral materials.

6. The plant according to claim 1, wherein the supply duct and the second extraction duct (12) are each equipped with a seal lock.

7. The plant according to claim 1, further comprising conveying means arranged to collect the residual coarse particles from the second extraction duct and lift these residual coarse particles up to the supply duct.

8. The plant according to claim 1, further comprising:
a hopper supplied in mineral materials, housed within the enclosure above the roller press;
means for measuring a magnitude representative of the quantity of mineral material contained in the hopper, such as the mass or the filling level of the hopper.

9. The plant according to claim 1, further comprising blocking and adjusting means suited to adjust the thickness and the position of the stream of material above the air gap between the rollers.

10. The plant according to claim 9, wherein the blocking and adjusting means comprise:
blocking means moveable in a blocking position and in a release position, respectively, preventing and allowing the supply of the roller press with mineral materials;
first motor means configured to move the blocking means in their release position or in their blocking position;
adjusting means moveable with respect to the blocking means; and
second motor means configured to move the adjusting means with respect to the blocking means, to adjust the thickness and the position of the material stream above the air gap (34) between the rollers.

11. The plant according to claim 1, wherein the or each roller press comprises at least a first and a second roller rotatably mounted about substantially parallel axes, and adjusting means adapted to adjust the width of the air gap separating the first and the second rollers.

12. The plant according to claim 11, wherein each roller press is combined with a respective first separator, each first separator comprising two portions of grids inclined with respect to each other, the portions of grids exhibiting lower edges turned towards a second respective mouth and upper edges joined to each other and disposed vertically with the air gap separating the first and the second rollers.

13. The plant according to claim 1, wherein the suction means comprise a fan disposed outside the enclosure.

14. The plant according to claim 1, wherein the second separator comprises a turbine rotatably mounted inside the enclosure and a plurality of bladings fixed to the inside of the enclosure concentric with the turbine.
